(19) United States
(12) Patent Application Publication
(10) Pub. No.: US 2008/0104872 A1
(43) Pub. Date: May 8, 2008

(54) Ornamental magnets

(76) Inventor: Gina Mertz, Mohnton, PA (US)

Correspondence Address: LITMAN LAW OFFICES, LTD., P.O. BOX 15035, CRYSTAL CITY STATION, ARLINGTON, VA, 22215, US

(21) Appl. No.: 11/976,036

(22) Filed: Oct. 19, 2007

Related U.S. Application Data
(60) Provisional application No. 60/856,029, filed on Nov. 2, 2006.

(51) Int. Cl. G09F 7/04

(52) U.S. Cl. 40/600

(57) ABSTRACT

The ornamental magnets provide at least one magnetic panel having opposed first and second surfaces, with the first surface having indicia imprinted thereon. The second surface is a magnetic sheet for attachment to a ferromagnetic surface, such as a refrigerator door. The panel may have an opening formed therethrough for placement around or over a handle extending from the ferromagnetic surface, such as a refrigerator door handle. Alternatively, a recess may be formed in the panel for receiving the handle. Further, a plurality of magnetic panels may be provided for releasably covering a periphery of the ferromagnetic surface, with the opening or recess being formed in at least one of the plurality of magnetic panels. A kit may include a plurality of the panels having indicia relating to a single, unified theme.

### CROSS-REFERENCE TO RELATED APPLICATION

This application claims the benefit of U.S. Provisional Patent Application Ser. No. 60/856,029, filed Nov. 2, 2006.

### BACKGROUND OF THE INVENTION

1. Field of the Invention

The present invention relates to decorations that can be applied to large appliances, such as refrigerators, and to other furnishings having a large ferromagnetic surface, and particularly to ornamental magnets in the form of interchangeable magnetic sheets with decorative surfaces that can be applied as borders or as full surface decorations.

2. Description of the Related Art

Large appliances, such as refrigerators, and large pieces of furniture, such as filing cabinets, typically have exposed external surfaces that are generally functional and utilitarian in appearance. Such surfaces are often formed from metallic materials, allowing users to decorate the surfaces with decorative and ornamental refrigerator magnets and the like. However, such refrigerator magnets are typically quite small with respect to the exposed external surface, and in order to cover an appreciable fraction of the surface, the user must attach an inordinately large number of the magnets to the appliance or furniture.

Such refrigerators, filing cabinets and the like typically have protrusions associated therewith, commonly in the form of handles and the like. Conventional refrigerator magnets and magnetic signs are only adapted for attachment to substantially planar metallic surfaces, and are not typically designed for placement about handles and the like. Thus, ornamental magnets solving the aforementioned problems are desired.

### SUMMARY OF THE INVENTION

The ornamental magnets provide at least one magnetic panel having opposed first and second surfaces, the first surface having decorative or ornamental indicia formed thereon. The second surface is a magnetic sheet adapted for attachment to a ferromagnetic surface, such as a refrigerator door. The magnetic panel at least partially covers the ferromagnetic surface.

Further, the magnetic panel may have an opening formed therethrough so that the magnetic panel can be placed around a handle extending from the appliance, such as a refrigerator door handle. Alternatively, a recess may be formed in the magnetic panel for accommodating the handle. Further, a plurality of magnetic panels may be provided for releasably covering a periphery of the ferromagnetic surface (such as the border of the refrigerator door, for example), with the opening or recess being formed in at least one of the plurality of magnetic panels.

The panels may be furnished in a kit having a decorative theme, such as Halloween, Thanksgiving, Christmas, etc., so that the panels are interchangeable and one kit can be replaced with another according to the season.

These and other features of the present invention will become readily apparent upon further review of the following specification and drawings.

### BRIEF DESCRIPTION OF THE DRAWINGS

FIG. 1 is an environmental, perspective view of ornamental magnets according to the present invention.

FIG. 2 is an environmental, side view of the ornamental magnets according to the present invention, showing the magnets being attached to a refrigerator.

FIG. 3 is a diagrammatic partial side view of an ornamental magnet according to the present invention.

FIG. 4 is an environmental, perspective view of an alternative embodiment of ornamental magnets according to the present invention.

FIG. 5 is a front view of another alternative embodiment of an ornamental magnet according to the present invention.

Similar reference characters denote corresponding features consistently throughout the attached drawings.

### DETAILED DESCRIPTION OF THE PREFERRED EMBODIMENTS

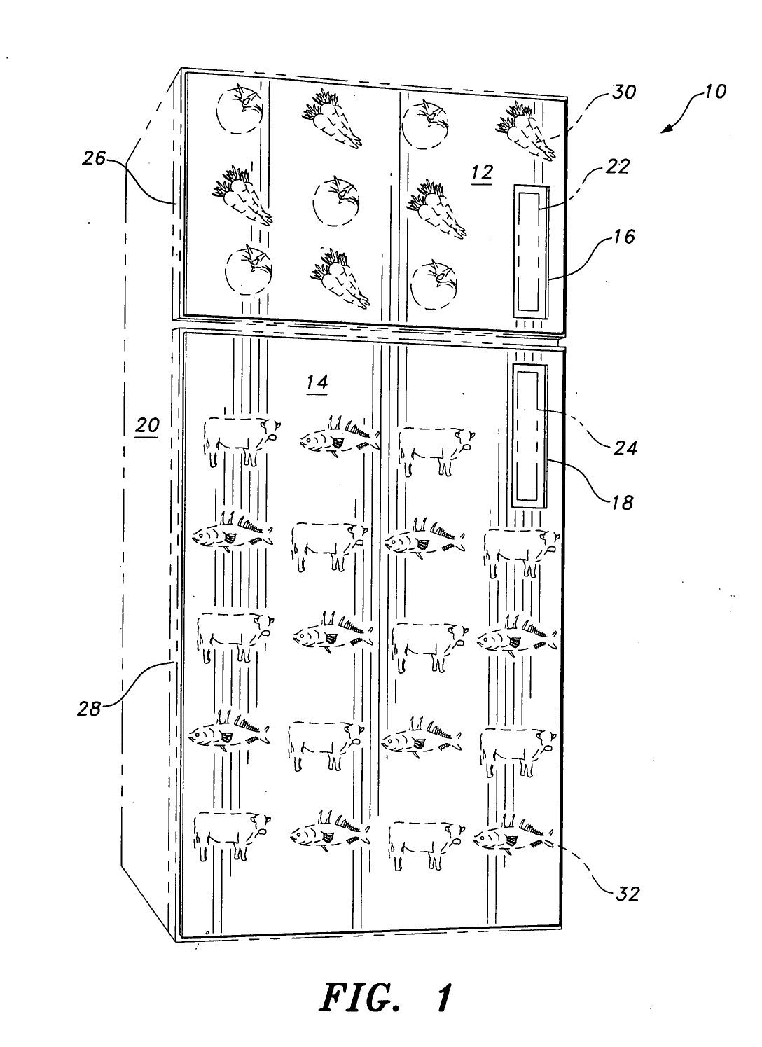

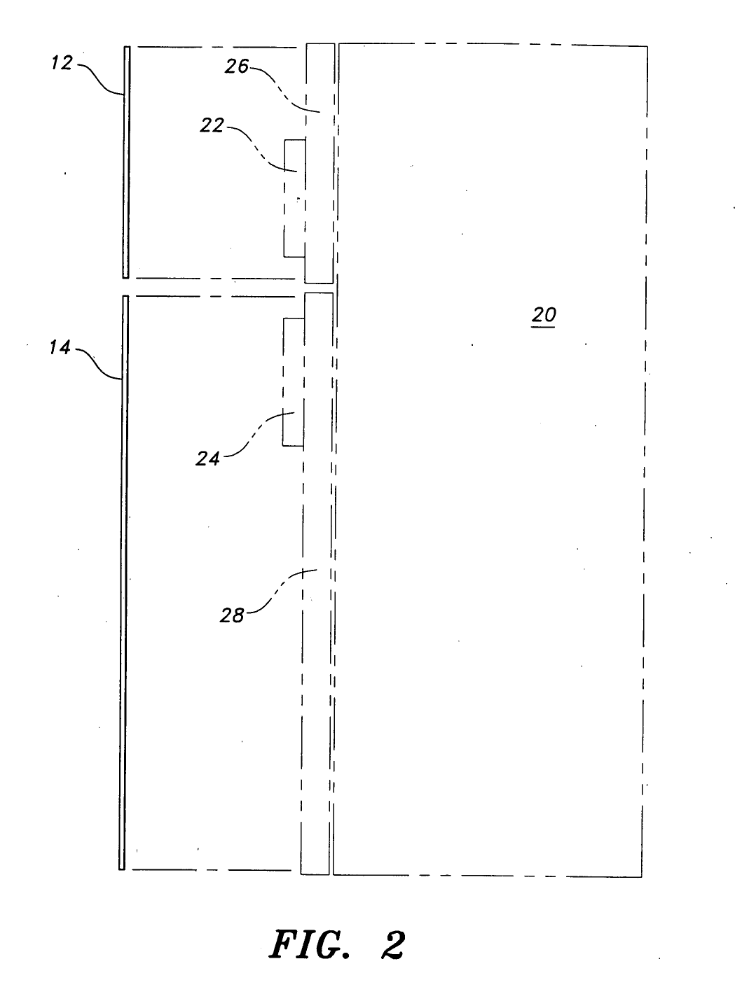

The present invention is directed towards ornamental magnets 10 for at least partially covering an external surface of an appliance, an article of furniture having a ferromagnetic surface, or the like. As shown in FIGS. 1 and 2, the ornamental magnets 10 provide at least one magnetic panel having opposed first and second surfaces, the first surface having decorative or ornamental indicia formed thereon, e.g., by imprinting the indicia thereon, etc. In FIG. 1, two such panels 12, 14 are provided, with upper panel 12 being configured to cover substantially the entire front surface of a freezer door 26 of combined refrigerator-freezer 20, and lower panel 14 being configured to cover substantially the entire surface of the refrigerator door 28.

It should be understood that combined refrigerator-freezer 20 is shown for exemplary purposes only, and that the ornamental magnets 10 may be applied to any suitable ferromagnetic surface, such as the doors of refrigerator-freezer 20, the drawers or side panels of a filing cabinet or other furnishing, a metallic door or the like. Further, any desired number of individual panels may be used according to the nature of the surface to be covered and the particular decorative or ornamental theme exhibited by the panels.

As illustrated in FIG. 1, upper panel 12 has first indicia 30 imprinted on the first (exposed) surface thereof, and lower panel 14 has second indicia 32 imprinted on the first (exposed) surface thereof. First and second indicia 30, 32 may include graphic patterns, geometric shapes, or thematic icons suitable for everyday display, as shown in the exemplary embodiment of FIG. 1, or may be thematically selected for holidays, birthdays or the like. Further, text messages may be imprinted on the panels.

The panels 12 and 14 may be furnished in kits having pairs or groups of panels that are coordinated into particular themes, e.g., seasonal decorations for Halloween, Thanksgiving, Christmas, etc., so that one kit can be removed from the refrigerator and interchangeably replaced by another. When furnished as a kit, the indicia on the upper panel 12 and the lower panel 14 may be identical, or may be complementary, being directed towards a single, unified theme. Alternatively, the panels 12 and 14 may be furnished as discrete components having separate, unrelated themes.

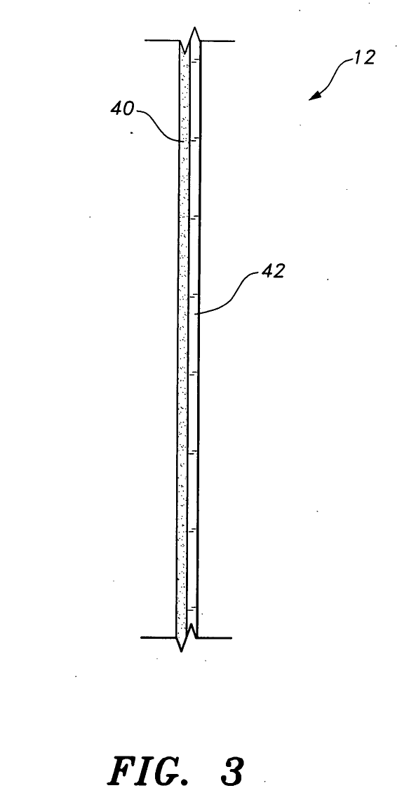

As shown diagrammatically in FIG. 3 (not to scale), each magnetic panel includes a magnetic sheet or layer 42 and a layer 40 capable of being imprinted with indicia formed thereon. The magnetic sheet 42 may be a thin layer of magnetic material, and the indicia layer 40 may be formed from rubber, plastic, ceramic, or other substrate that may receive ink, pigments, paint, or other material imprinted thereon. The layer 40 may be laminated to the magnetic layer 42 through any suitable method.

The second surface of each magnetic panel 12, 14 is adapted for releasable magnetic attachment to the ferromagnetic surface, such as the exemplary doors 26, 28. Although shown as having substantially rectangular contours and covering substantially the entire front surface of the respective doors 26, 28, it should be understood that magnetic panels may have any desired dimensions or configuration, and may cover only ¾ of each door, or may only provide a decorative border, etc.

Further, each magnetic panel 12, 14 may have an opening 16, 18, respectively, formed therethrough for placement around or over an appliance handle 22, 24, the handle extending through the opening 16, 18. Openings may also be formed to accommodate other features built into the appliance or furniture door or wall, e.g., an icemaker built into a refrigerator door.

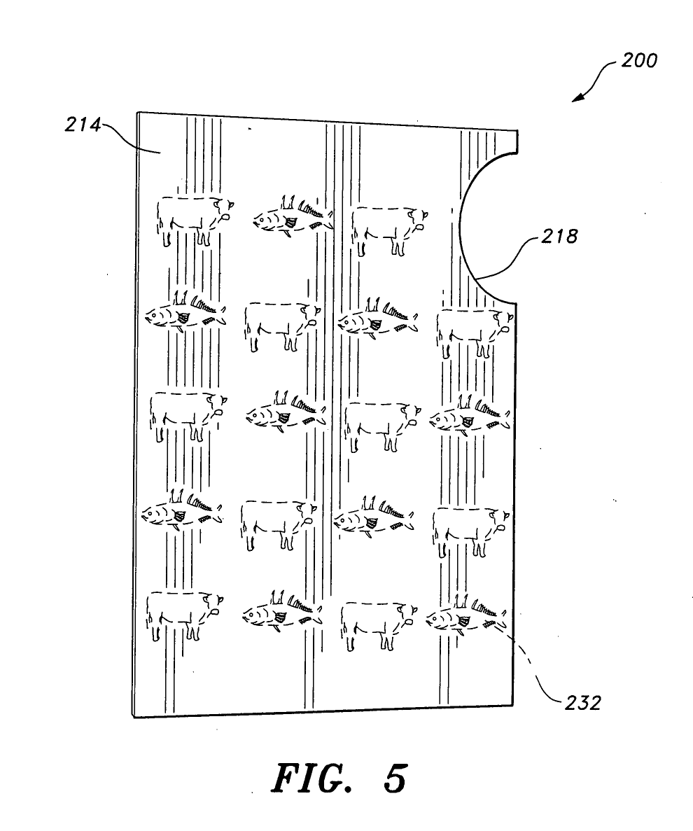

Alternatively, as illustrated in FIG. 5, a recess 218 may be formed in the magnetic panel 214 for accommodating the corresponding handle. In FIG. 5, the ornamental magnetic surface 200 includes at least one panel 214, similar to panels 12, 14, described in detail above, with indicia 232 being imprinted thereon. Openings 16, 18 are replaced, in this embodiment, with recess 218, which may have any suitable size and shape.

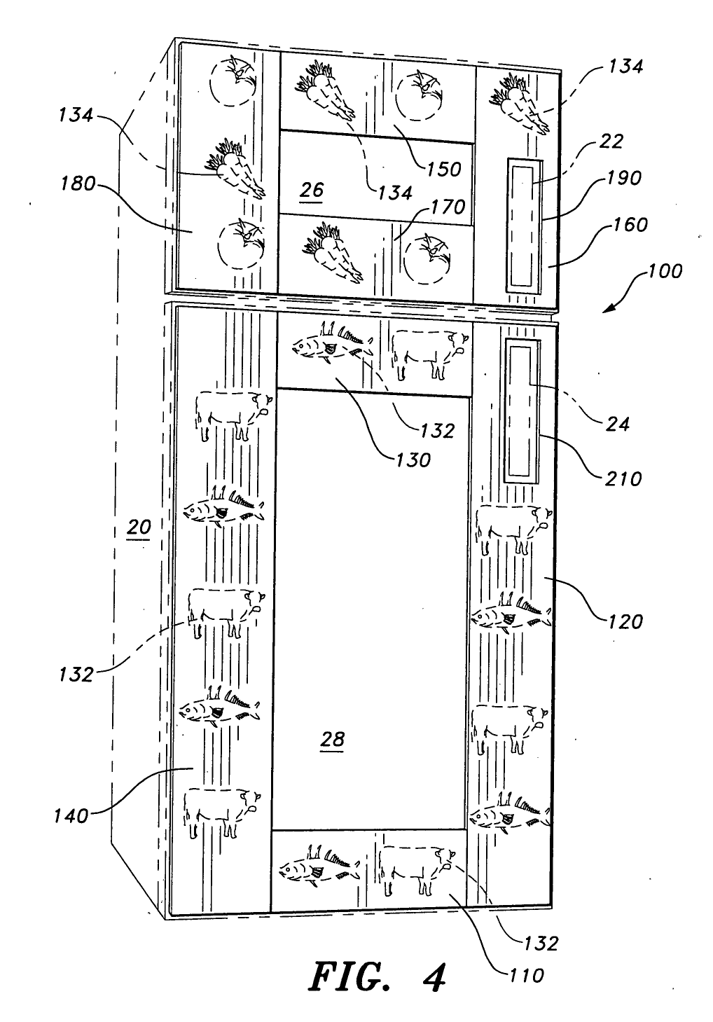

Further, as illustrated in the embodiment of FIG. 4, a plurality of magnetic panels 110, 120, 130, 140, 150, 160, 170, 180 may be alternatively provided for releasably covering a periphery of the ferromagnetic surface (such as the borders of the refrigerator door 28 and the freezer door 26). Each magnetic panel 110, 120, 130, 140, 150, 160, 170, 180 is similar in construction to panels 12, 14, described in detail above, with exemplary indicia 132 being imprinted on lower panels 110, 120, 130, 140 and with exemplary indicia 134 being imprinted on upper panels 150, 160, 170, 180. An opening 190 is formed through upper panel 160, similar to opening 16 of upper panel 12 of FIG. 1, and a similar opening 210 is formed through lower panel 120, similar to opening 18 of lower panel 14 of FIG. 1. It should be understood that openings 190, 210 may be replaced with suitable recesses, as described above with respect to FIG. 5.

Further, though upper panels 150, 160, 170 and 180 are shown as having substantially rectangular contours to cover the border of freezer door 26, and lower panels 110, 120, 130 and 140 are also shown as having substantially rectangular contours to cover the border of refrigerator door 28, it should be understood that panels 110, 120, 130, 140, 150, 160, 170 and 180 may have any suitable configuration.

It is to be understood that the present invention is not limited to the embodiments described above, but encompasses any and all embodiments within the scope of the following claims.

I claim:

1. An ornamental magnet, comprising at least one panel having opposed first and second surfaces, the first surface of the at least one panel having ornamental indicia formed thereon, the second surface being a magnetic sheet adapted for magnetic attachment to a ferromagnetic surface, the at least one panel having an opening formed therethrough for placement over a handle extending from the ferromagnetic surface, the handle extending through the opening.

2. The ornamental magnet as recited in claim 1, wherein the at least one panel comprises an upper panel and a lower panel, the upper panel being dimensioned and configured for magnetic attachment to a freezer door, the handle of the freezer door extending through the opening formed therethrough, the lower panel being dimensioned and configured for magnetic attachment to a refrigerator door, the handle of the refrigerator door extending through the opening formed therethrough.

3. The ornamental magnet as recited in claim 1, wherein the opening formed through the at least one panel extends from a central region thereof to the perimeter thereof, the opening forming a recess in a side edge of the at least one panel.

4. An ornamental magnet, comprising a plurality of panels, each of the panels having opposed first and second surfaces, the first surface of each of the panels having ornamental indicia formed thereon, the second surface of each of the panels being a magnetic sheet adapted for attachment to a ferromagnetic surface, the plurality of panels being adapted to cover a periphery of the ferromagnetic surface, at least one of the panels having an opening formed therethrough for placement over a handle extending from the ferromagnetic surface, the handle extending through the opening.

5. A kit of ornamental magnets, comprising a plurality of panels, each of the panels having a substrate laminated onto a magnetic sheet, the panels being dimensioned and configured for covering a freezer door and a refrigerator door, including substantially the entire front surface of the freezer and refrigerator doors, respectively, of a combination refrigerator-freezer by magnetic attachment thereto.

6. The kit of ornamental magnets as recited in claim 5, wherein the panel substrates each have user-selectable thematic indicia imprinted thereon, the user-selectable thematic indicia of each of the panel substrates having a single, unified theme with respect to one another.

7. The kit of ornamental magnets as recited in claim 5, wherein each of the panel substrates has user-selectable thematic indicia imprinted thereon, the user-selectable thematic indicia of each of the panel substrates being separate and distinct from the other.

8. The kit of ornamental magnets as recited in claim 5, wherein each of the panel substrates has an opening formed therethrough for receiving a door handle of the combination refrigerator-freezer.

9. The kit of ornamental magnets as recited in claim 5, wherein each of the panels has a recess formed in a side edge thereof for receiving a door handle of the combination refrigerator-freezer.
